(19) United States
(12) Patent Application Publication
(10) Pub. No.: US 2005/0057761 A1
(43) Pub. Date: Mar. 17, 2005

(54) Printing system, method of data processing in printing system, program, and memory medium

(75) Inventors: Mamoru Sakai, Kawasaki-shi (JP); Mikihiro Kajihara, Matsumoto-shi (JP); Yoichi Hine, Tokyo (JP); Toshinori Nojima, Tokyo (JP); Takanobu Kameda, Tokyo (JP)

Correspondence Address: HOGAN & HARTSON L.L.P., 500 S. GRAND AVENUE, SUITE 1900, LOS ANGELES, CA, 90071-2611, US

(73) Assignees: SEIKO EPSON CORPORATION; KING JIM CO., LTD.

(21) Appl. No.: 10/910,781

(22) Filed: Aug. 2, 2004

(30) Foreign Application Priority Data
Aug. 28, 2003 (JP) 2003-304263

(51) Int. Cl. H04N 1/387; H04N 1/393; G06F 3/12; G06F 15/00

(52) U.S. Cl. 358/1.2; 358/1.18; 358/1.14

(57) ABSTRACT

In an outputting apparatus, when a set tape width whose setting has been made in advance and a mounted tape width as reported by a tape printing apparatus are different from each other, a basic image data prepared (stored) to suit the set tape width is deformed to suit the mounted tape width, thereby preparing a deformed image data. When the tape width is different, the deformed image data is outputted as the print image data to the tape printing apparatus through an interface. The print image based on the print image data is printed on a tape. In a separate type of printing system, even when the set tape width as set in the outputting apparatus which outputs the data and the mounted tape width as mounted on the tape printing apparatus are different from each other, printing can be forcibly executed without giving rise to particular problems.

### BACKGROUND OF THE INVENTION

1. Field of the Invention

This invention relates to a printing system, a method of data processing in the printing system, a program, and a memory medium. The printing system is a separate type of tape printing apparatus which is made up of an outputting (or transmitting) apparatus which outputs (or transmits) print image data, and a printing apparatus (tape printing apparatus) which prints the print image based on the print image data.

2. Description of the Related Art

Conventionally, in this kind of printing system (separate type of tape printing apparatus), if the width of the tape which is set at the stage of preparing (forming or storing) the print image data (set tape width: imaginary tape width) is different from the width of the tape which is actually mounted or loaded on the tape printing apparatus, a display is made to that effect. The user is thus urged to mount a tape (actually, a tape cartridge or cassette having mounted thereon the tape in question) which coincides with the set tape width (i.e., the tape width that has been set in advance). In case the printing job is executed or performed as it is, the following problems are known to occur. Namely, the tape printing apparatus (especially the thermal type of printing head, platen, or the like) may give rise to mechanical problems due to outputting of the print image data which does not suit the mounted tape width, or extra processing time may be required due to excessive data communication, or the like.

However, a tape (tape cartridge) having a tape width that is the same as the set tape width is not always readily available at hand and, therefore, a user sometimes may wish to use a tape of different tape width which is available at hand, thereby printing a print image thereon (or cutting it into a label). Otherwise, it is troublesome or is sometimes even difficult to set again (or change the setting of) the set tape width to suit the tape that is readily available at hand and to prepare the image data once again. Further, in a separate type of tape printing apparatus, the outputting apparatus and the tape printing apparatus are sometimes disposed apart from each other (e.g., in separate rooms, or the like). In such a case, it is sometimes difficult to grasp the kinds of the tape cartridges, or the like, that can be made available on the part of the tape printing apparatus.

### SUMMARY OF THE INVENTION

This invention has an advantage of providing a printing system which, in a separate type of printing system, the printing can be forcibly executed without giving rise to a particular problem even in case a width of a tape which is set by the outputting (transmitting) apparatus (set tape width) which output (transmits) data and a width of a tape which has been mounted on a tape printing apparatus (mounted tape width) are different from each other. This invention also has an advantage of providing a method of data processing in the printing system, a program, and a memory medium.

According to this invention, there is provided a printing system comprising: an outputting apparatus for outputting print image data through an interface; and a tape printing apparatus for printing on a tape a print image based on the print image data outputted or transmitted through the interface. The tape printing apparatus comprises tape width reporting means for reporting to the outputting apparatus a tape width of the tape mounted thereon as a mounted tape width. The outputting apparatus comprises: basic image storing means for storing basic image data of a size depending on the width of a tape set in advance; deformed image forming means for forming deformed image data by deforming the basic image data into a size depending on the mounted tape width when the set tape width and the mounted tape width are different from each other; and image data outputting means for outputting the deformed image data to the tape printing apparatus as the print image data.

According to another aspect of this invention, there is provided a method of data processing in a printing system which prints on a tape a print image based on print image data outputted from an outputting apparatus to a tape printing apparatus trough an interface. The method comprises: the tape width reporting step for reporting to the outputting apparatus a tape width of the tape mounted thereon as a mounted tape width; basic image storing step for storing into the outputting apparatus basic image data of a size to suit a set tape width that has been set in advance; deformed image forming step for forming deformed image data by deforming the basic image data into a size to suit the mounted tape width when the set tape width and the mounted tape width are different from each other; and image data outputting step for outputting the deformed image data by the outputting apparatus to the tape printing apparatus as the print image data.

In this printing system and method of data processing therein, the outputting apparatus performs the following function. Namely, when the set tape width and the mounted tape width are different from each other, the basic image data prepared or stored to suit the set tape width is deformed to suit the mounted tape width to thereby form deformed image data. The deformed image data is outputted to the printing apparatus as the print image data through the interface (when the tape widths are equal to each other, the basic image data or the deformed image data is outputted as the print image data). In this case, the image data to be outputted as the print image data becomes the image data that suits the mounted tape width not only in case where both the tape widths are equal to each other, but also in case where both the tape widths are different from each other, giving rise to no particular problem. In other words, even in case where only a tape whose width is different from the width of the set tape cannot be made available, the method of deforming the image data (method of deforming the print image: predetermined printing method) can be determined in advance so as to be able to deform the print image by taking such a circumstance into consideration in advance. The printing can thus be forcibly executed without giving rise to a particular problem. For example, if the print image for narrow width (with addition of margins) is printed on a tape of large width that is available, the surplus margins can be cut off after printing. Or else, only a widthwise part of a desired print image is extracted to thereby print it on a tape of narrow width that can be made available so that different parts are printed on a plurality of pieces. In this manner, plural pieces are put together to consequently obtain a print image on a tape (label) of desired width, or enlarge/reduce the print image to suit the mounted tape width. As a result of deforming the image as described above, even in case where the set tape width and the width of the tape mounted on the tape printing apparatus are different from each other, the printing job can be forcibly executed without giving rise to a particular problem.

In the above-described printing system, preferably the outputting apparatus comprises: printing instruction means for giving instruction to print the print image; printing instruction canceling means for canceling the printing instruction when the printing instruction is given and when the set tape width and the mounted tape width are different from each other; and forced (forcible or compulsory) printing instruction means for instructing forced printing of the printing image when the printing instruction is given and when the set tape width and the mounted tape width are different from each other. The image data outputting means outputs the deformed print image data as the print image data when the forced printing instruction is given.

In this printing system, when the printing instruction has been given and when the tape widths are different, the outputting apparatus is conveniently capable of canceling the printing instruction or giving a forced printing instruction. In addition, when the forced printing instruction has been given, the deformed print image is outputted as the print image data. Therefore, the print image suitable for the mounted tape width can be outputted, giving rise to no particular problem.

In the above-described printing system, preferably the deformed image forming means comprises at least one of: image enlarging/reducing means for forming the deformed image data by deforming the basic image data in order to enlarge or reduce the widthwise size of the basic image data to suit the mounted tape width; and image width extracting and adding means for extracting from the basic image data an amount equivalent to the mounted tape width when the set tape width is above the mounted tape width, thereby forming the deformed image data, and for adding to the basic image data a margin width data to thereby increase the basic image data to an amount equivalent to the set tape width when the set tape width is below the mounted tape width, thereby forming the deformed image data.

In this printing system, it is possible to employ in the outputting apparatus one of: the deforming method by enlargement/reduction in which the width of the basic image is deformed to be enlarged from the one equivalent to the set tape width to the one equivalent to the mounted tape width and; the deforming method by extraction and addition in which the value or amount equivalent to the mounted tape width is extracted (or the remaining portion is deleted) from the basic image data, or in which the margin width data to enlarge up to the amount equivalent to the mounted tape width is added to the basic image data. Therefore, even if the tape widths are different, the printing can be forcibly executed with the image data suitable for the mounted tape width serving as the print image data, without giving rise to particular problems.

According to another aspect of this invention, there is provided a program for effecting each of the means in the above-described printing system.

According to still another aspect of this invention, there is provided a program for effecting the method of data processing in the above-described printing system.

Since these programs are processed by the programmable printing system, even in case, in a separate type of printing system, the set tape width which is set in an outputting apparatus which outputs the data is different from the mounted tape width as mounted on the tape printing apparatus, the printing can be forcibly executed without giving rise to particular problems.

Further, according to still another aspect of this invention, there is provided a storage medium for storing the above-described programs in a manner to be readable by the programmable printing system.

In a programmable printing system, by reading out and executing the program stored in the storage medium, the printing can be forcibly executed in a separate type of printing system even in case the set tape width which has been set by the outputting apparatus which outputs the data and the mounted tape width as mounted on the tape printing apparatus are different from each other, without giving rise to a particular problem.

### BRIEF DESCRIPTION OF THE DRAWINGS

The above and other objects and the attendant features of this invention will become readily apparent by reference to the following detailed description when considered in conjunction with the accompanying drawings wherein:

FIG. 1 is a schematic view diagram showing an example of a first constitution of a printing system of this invention;

FIG. 2 is a schematic view similar to the one in FIG. 1, showing a second constitution;

FIG. 3 is a perspective outside view of a tape printing apparatus of FIG. 1 or FIG. 2;

FIG. 4 is a perspective view in a state in which an opening-closing lid of the tape printing apparatus has been removed;

FIG. 5 is a block diagram showing a general arrangement of a control system of the tape printing apparatus;

FIG. 6 is a flow chart showing a general processing of the entire control of the tape printing apparatus;

FIGS. 7A and 7B are a display screen (7A) showing one example at the time of printing and an explanatory view showing typical operations on the screen and one example (7B) showing the result of printing;

FIG. 8 is an explanatory view showing one example a dialog box of a printer driver and a confirmation screen of a tape width and printing execution, as one example of window screens of a data server;

FIGS. 9A and 9B explanatory views showing one example of a confirmation screen (9A) of the tape width and the printing execution and a corresponding printing result (9B);

FIGS. 10A and 10B are explanatory views similar to those in FIGS. 9A and 9B;

FIGS. 11A and 11B are explanatory views showing another example corresponding to the confirmation screen in FIGS. 9A and 9B;

FIG. 12 is an explanatory view showing one example of a selection screen of the position of disposing the basic image corresponding to the confirmation screen;

FIG. 13 is an explanatory view showing an example of selection screen for performing the same selection as in FIG. 12 in the tape printing apparatus;

FIGS. 14A and 14B are explanatory views showing another example of the printing result corresponding to the confirmation screen in FIG. 10A;

FIG. 15 is an explanatory view showing one example of selection screen in the extraction position of a deformed image corresponding to the confirmation screen in FIG. 10A;

FIGS. 16A and 16B are explanatory views showing one example of the selection screen in data deforming method in the data server and the tape printing apparatus;

FIGS. 17A and 17B are explanatory views showing one example of the selection screen for selecting between forced printing and printing cancellation at the time of tape width disagreement and non-display;

FIG. 18 is an explanatory view, similar to FIG. 1, showing a third constitution; and

FIG. 19 is an explanatory view, similar to FIG. 5, showing a third constitution in FIG. 18.

### DETAILED DESCRIPTION OF THE PREFERRED EMBODIMENTS

With reference to the accompanying drawings, a description will now be made about a tape printing system according to an embodiment of this invention.

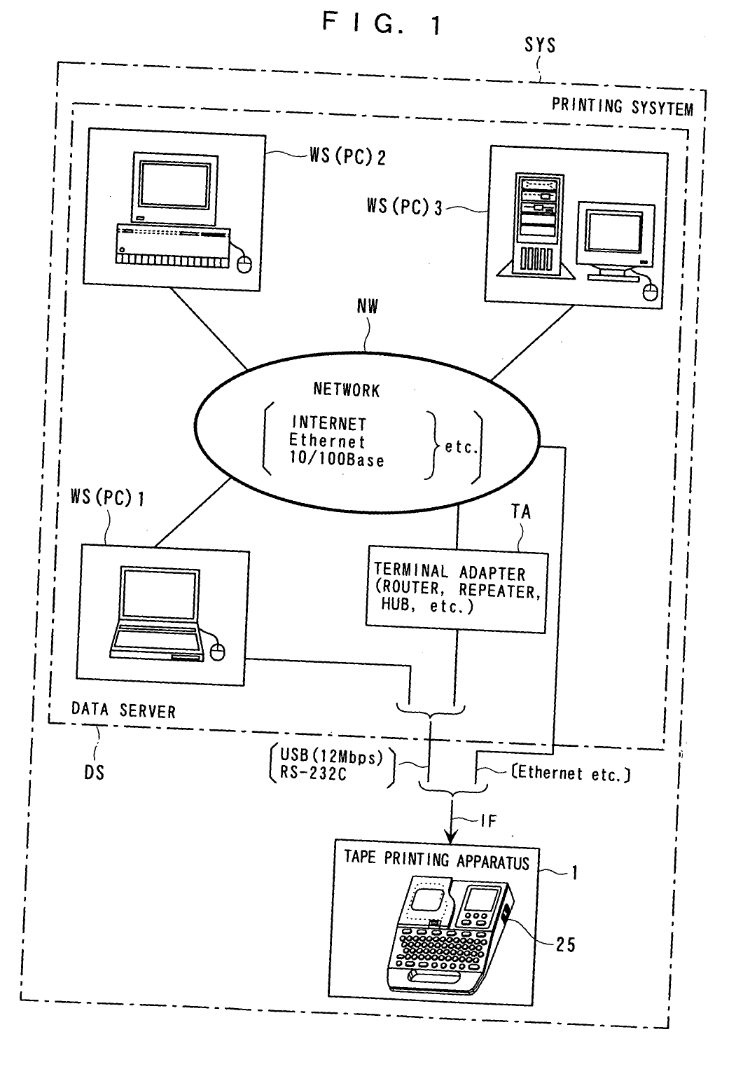

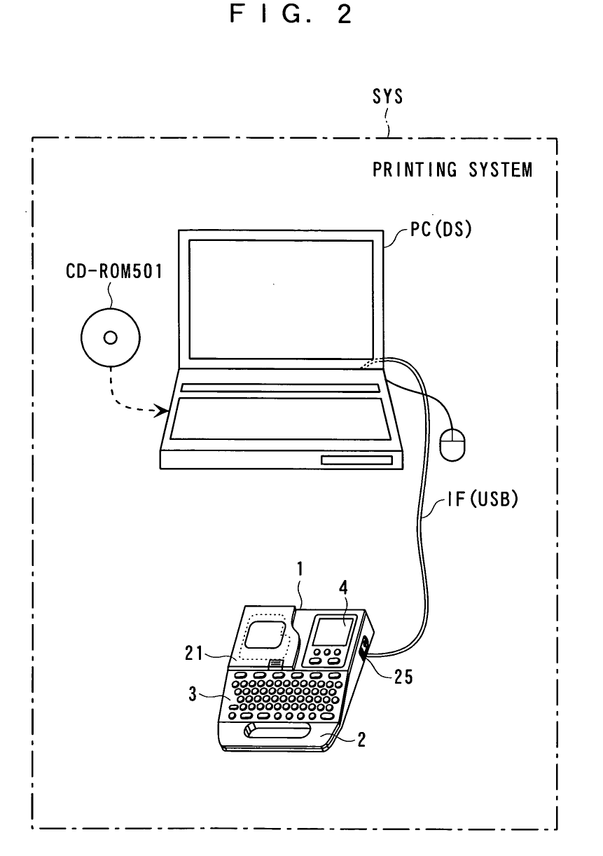

As shown in FIGS. 1 and 2, the printing system SYS is constituted in a manner to be regarded as a single tape printing apparatus (separate type of tape printing apparatus) as a whole, and is made up of a data server (outputting or transmitting apparatus) DS and a tape printing apparatus 1, which are connected together about an interface IF.

The data server DS has a function to serve or provide the tape printing apparatus 1 with print image data which is an object to be printed. For this purpose, the data server DS of the first embodiment shown in FIG. 1 is constituted by connecting together, through a network NW, a plurality of workstations WS (personal computers PC, or the like) 1-3 which form terminals, and a terminal adapter (inclusive of a router, a repeater, a hub, or the like) TA. One of these terminals is connected to the tape printing apparatus 1 through the interface IF or as a direct interface IF from the network NW.

In this case, as the network NW, there may be employed one according to communication protocols compliant with the IEEA standard LAN, e.g., so-called the Internet, various local area networks (LAN: Ethernet (trademark), 10/100 Base, or the like). The interface IF through the terminals may be of either serial data communication (RS-232C, USBs, IEEE1394, or the like) or parallel data communication (Centronics, or the like). Although the above are standards for wire communication, wireless communication may also be used.

Alternatively, as a simpler constitution, the data server DS may be arranged as a stand-alone type of apparatus. For example, as shown in FIG. 2, by simply connecting the stand-alone type of personal computer PC with the tape printing apparatus 1 through the interface IF such as the USB, or the like, the printing system SYS can be constituted.

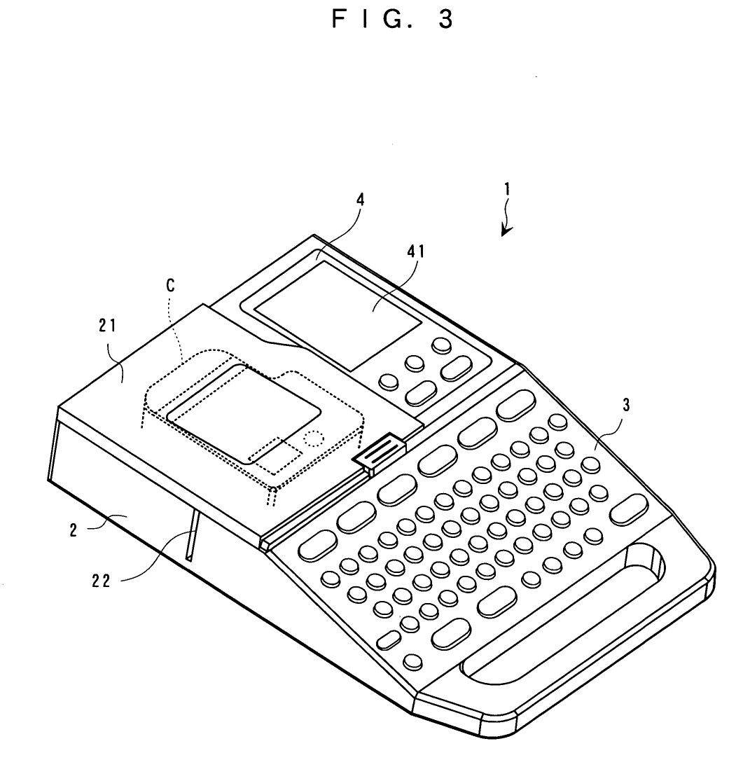

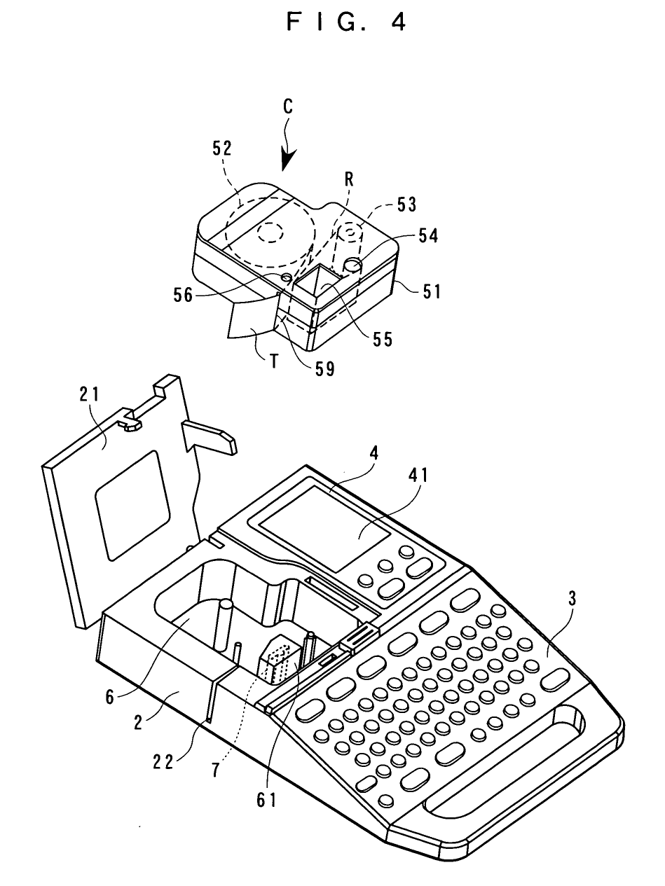

A shown in FIGS. 3 and 4, the tape printing apparatus 1 has an outer shell which is formed by an apparatus casing (apparatus main body) 2. On a front upper surface of the apparatus casing 2, there is provided a keyboard 3 which is made up of various input keys. On a rear upper surface thereof, there is attached an opening-closing lid 21 on the left side thereof, and a display 4 is disposed on the right side thereof. On the left side of the apparatus casing 2, there is formed a slit-like tape discharge port (opening) 22 which communicates a pocket (tape mounting part) 6 with an outside of the apparatus. The tape discharge port 22 has disposed therein a tape cutter 132 for cutting a printing tape (hereinafter referred to also as a “tape”) that has been discharged.

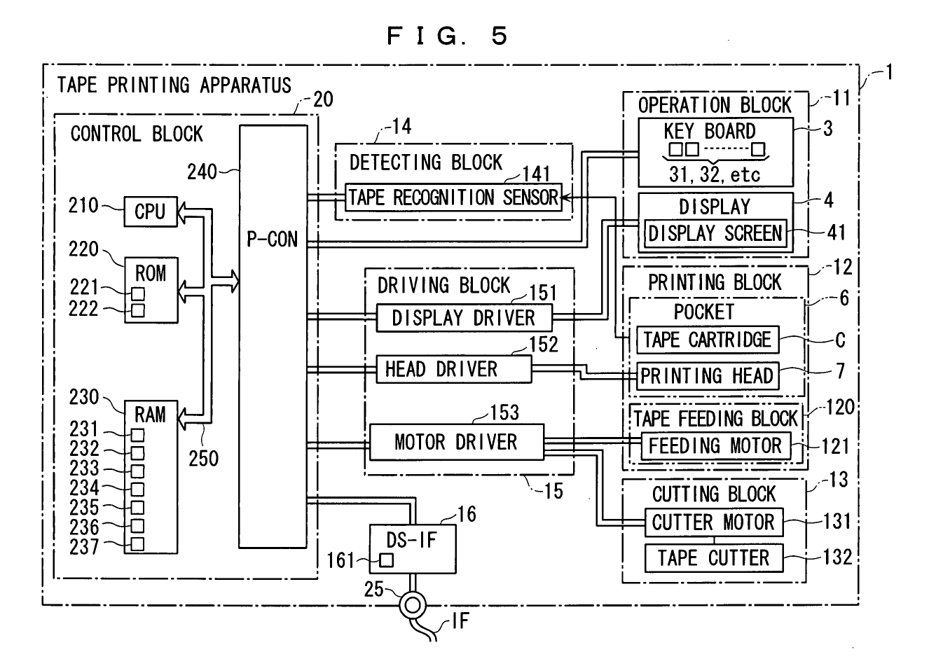

As shown in FIG. 5, the tape printing apparatus 1 is made up of a constitution which is similar to the one for the stand-alone type of tape printing apparatus, and a data outputting interface (DS-IF) 16 which is added thereto. The DS-IF is to execute communication, e.g., according to the second embodiment in FIG. 2, from the interface IF through the USB connector 25 to the data server DS based on the USB specification (protocol), and has a receiving buffer 161 for receiving various data (print image data, or the like) from the data server DS.

The basic constitution as seen from the viewpoint of the control system is made up of: an operation block 11 which has the keyboard 3 and the display 4 and which serves the function of interface with a user; a printing block 12 which has a printing head (thermal head) 7 and a tape feeding block 120 which performs or executes printing of the tape T of a tape cartridge C which is mounted inside the pocket 6; a cutting block 13 which performs cutting of the printed tape T; a detection block 14 which has various sensors and performs various detections; a driving block 15 which has various drivers and drives circuit of each of the blocks; the above-described DS-IF 16; and a control block 20 which controls each of the blocks of the tape printing apparatus 1.

The apparatus casing 2 has mounted therein a circuit board (not illustrated), aside from the printing block 12, the cutting block 13, the detection block 14, or the like. This circuit board has mounted thereon each of the circuits for the driving block 15 and the control block 20, aside from a power unit, and is connected to a connection outlet for an AC adapter or a battery (not illustrated) such as a Ni—Cd battery which is replaceable from outside.

In the tape printing apparatus 1, after mounting a tape cartridge C into the pocket 6, the user then inputs through the keyboard 3 print information such as desired characters (letters, figures, marks, symbols, or the like) by confirming the result of input and edition on the display 4. Upon subsequent command of printing, the tape T is fed (or taken out) of the tape cartridge C by means of the tape feeding block 120, thereby executing desired printing on the tape T by means of the printing head 7. The portion having printed thereon the necessary print image (also referred to as printed portion) is discharged outside through the tape discharge port 22. Once the desired printing has been finished, the tape feeding block 120 feeds the tape T up to the position of the tape length inclusive of the margin, and then stops the feeding operation.

As shown in FIGS. 4 ad 5, the printing block 12 is provided, on the inside of the opening-closing lid 21, with the pocket 6 for mounting the tape cartridge C therein. The tape cartridge C is mounted on, and dismounted from, the pocket 6 in a state in which this opening-closing lid 21 is left open. The tape cartridge C is provided, on the rear surface thereof, with a plurality of small holes (not illustrated) so as to enable recognition of the kind of the tape T with different widths, or the like. The pocket 6 is provided with a tape recognition sensor 141 such as a micro-switch, or the like, to detect the presence or absence of these holes. It is thus so arranged that the presence or absence (strictly speaking, as to whether the tape cartridge C is mounted or not) as well as the kind of the tape T (strictly speaking, the kind of the tape cartridge C) can thus be detected.

The tape cartridge C is constructed such that a cartridge casing 51 contains therein a tape T and an ink ribbon R of a predetermined width (about 4.5 mm-48 mm) and that a through opening 55 is formed to which the printing head 7 faces. The tape T has an adhesive layer which is formed on a rear surface thereof, and the adhesive layer is covered with a release (peel-off) paper. In a portion in which the tape T and the ink ribbon R are overlapped with each other, there is contained a platen roller (platen) 56 in a manner to correspond to the printing head 7 housed (or contained) inside the head unit 61. In a state in which the tape cartridge C is mounted, the printing head 7 comes into contact with the rear surface of the ink ribbon R that is exposed from the through opening 55 and, due to thermal driving, the desired characters, or the like, are printed on the front surface of the tape T.

The tape feeding block 120 is disposed in a space of a side portion of the pocket 6 and downward, and is provided with a feeding motor 121 as the power (driving) source. Once the tape cartridge C is mounted in the pocket 6 and the opening-closing lid 21 is closed in that state, the tape T is fed out of a tape reel 52 and the ribbon R is fed from a ribbon feeding reel 53 with the feeding motor 121 serving as the driving source. As a result, the printing head 7 comes into contact with the platen 56 at a position of the through opening 55 in a state in which the tape T and the ink ribbon R are sandwiched therebetween. The tape T and the ink ribbon R travel in an overlapped state and the printing head 7 is driven in a synchronized manner, thereby executing printing. Thereafter, only the tape T is discharged outside the tape cartridge C. The platen 56 is then kept on rotating (a ribbon take-up reel 54 is also rotated in a synchronized manner) for a predetermined period of time. The tape T is thus discharged through the tape discharge port 22 to the outside of the printing apparatus, and a predetermined cutting position of the tape T is fed to the position of the tape cutter 132.

The cutting block 13 is provided with the tape cutter 132, and the cutter motor 131 which operates the tape cutter to perform cutting operation. The cutting block 13 is capable of switching between automatic operation and manual operation by mode setting. In case of printing of an arbitrary length, the cutting key for manual operation (manual) is operated, and in case of printing of a fixed length, the cutting key for automatic printing (auto) is operated to thereby drive the cutter motor 131. The detection block 14 is provided, inside the apparatus, with various kinds of sensors, aside from the above-described tape recognition sensor 141. The driving block 15 is provided with a display driver 151, a head driver 152, and a motor driver 153. The display driver 151 drives the display 4 of the operation block 11 according to a command based on a control signal to be issued by the control block 20. Similarly, the head driver 152 drives the printing head 7 of the printing block 12. The motor driver 153 drives the various motors such as the feeding motor 121 of the printing block 12, the cutter motor 131 of the cutting block 13, or the like.

The operation block 11 is provided with the keyboard 3 and the display 4. Inside a rectangular shape of about 6 cm in width (X direction) and 4 cm in length (Y direction), the display 4 has a display screen 41 which is capable of displaying display image data of 96 dots × 64 dots, and 18 indicators (not illustrated) which display various setting conditions, or the like. The display 4 is used by the user to input data from the keyboard 3 in preparing and editing the print image data such as character string image data, in visually recognizing the result thereof, in inputting various commands and selection instructions from the keyboard 3, or the like.

The keyboard 3 has disposed therein a character key group 31 inclusive of alphabetical key group, numerical key group, Japanese “kana” key group such as “hirakana”, “katakana”, or the like, and external character key group for calling up external characters and selecting them, as well as function key group 32 for designating various operation modes, or the like.

The function key group 32 includes power supply key, print key for commanding the printing operation, selection key for data determination and changing line at the time of text inputting and for selecting and commanding various modes in selection screen, delete key for deleting various operations or for deleting characters when necessary after having fixed them, cutting key for executing the above-described manual cutting, four cursor keys for moving the cursor and display range on the display screen 41 in the up and down as well as in the left and right directions, or other keys. It is possible to provide independent keys for each key inputting, or to utilize them by combination with shift key, or the like, so that input can be made by smaller number of keys. The keyboard 3 is used to input various commands and data into the control block 20 by means of these various keys.

The control block 20 is provided with CPU 210, ROM 220, RAM 230 and peripheral controller (P-CON) 240, which are connected to one another by means of an internal bus 250. The ROM 220 has a control program area 221 which stores therein a control program for processing in the CPU 210, and a control data area 222 which stores therein font data of characters, or the like, (inclusive of numerals, marks, figures, or the like) prepared in the apparatus, color conversion table, character modification table, or the like. The RAM 230, which is backed up for power-off, has various flag/register group 231, text data area 232, display image data area 233, print image data area 234, drawing register image data 235, external character register image data area 236, buffer area 237 such as character development buffer, print buffer, or the like, and is used as a working area for various processing.

The P-CON 240 has built therein a logic circuit which supplements the function of the CPU 210 and also handles the interface signals with the peripheral circuits, a function circuit such as a timer which performs various counting, or the like, all being constituted by gate array, custom LSI, or the like. Therefore, the P-CON 240 is connected to the various sensors in the detection block 14 and the keyboard 3. Various detected signals and various command signals, input data, or the like, are taken into the internal bus 250 as they are or with due processing. In cooperation with the CPU 210, the data control signal outputted from the CPU 210 into the internal bus 250 are outputted to the driving block 15 as they are or after due processing.

According to the above-described arrangement, the CPU 210 inputs various detection signals, various commands, various data, or the like, according to the control program in the ROM 220, and processes various data, or the like, inside the ROM 220 and the RAM 230 for further outputting of the control signal into the driving block 15 or to the DS-IF16 through the P-CON 240. While executing communication of various control signals and various data (transmission and receiving), the print position control, the display control of the display screen 41 are performed and also the printing head 7 is controlled to print on the tape T under the given printing conditions, whereby the entire tape printing apparatus 1 is controlled.

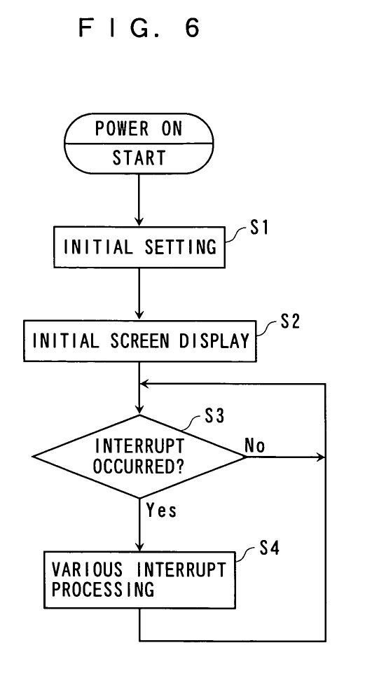

A description will now be made about the processing flow of the entire control of the tape printing apparatus 1 with reference to FIG. 6. When the processing begins by switching on the apparatus (power ON), initialization is performed to bring the state to the one at the time of the last power off such as by restoring each of the saved control flags, or the like (S1). Then, the display screen of the last time is displayed as the initial screen (S2).

The subsequent processing in FIG. 6, i.e., a judgment as to whether there is a key input or not (S3) and various interrupt processing (S4), are shown only conceptually. Actually, in the tape printing apparatus 1, when the initial screen display (S2) has been finished, interrupt by means of the key input, or the like, is accepted and, until another interrupt occurs, the state is maintained as it is (S3: NO). If interrupt occurs (S3: YES), the program proceeds to the respective interrupt processing (S4). If that interrupt processing is finished, that state is maintained again (S3: NO).

As described above, in the tape printing apparatus 1, the main processing is performed by interrupt processing. Therefore, if the preparations for print image forming have been made, the user may press the print key at an arbitrary timing. Then, the printing interrupt occurs, the printing processing is started up, and the printing of the print image can be prepared based on the print image data. In other words, the operating procedure to the printing can be arbitrarily selected by the user.

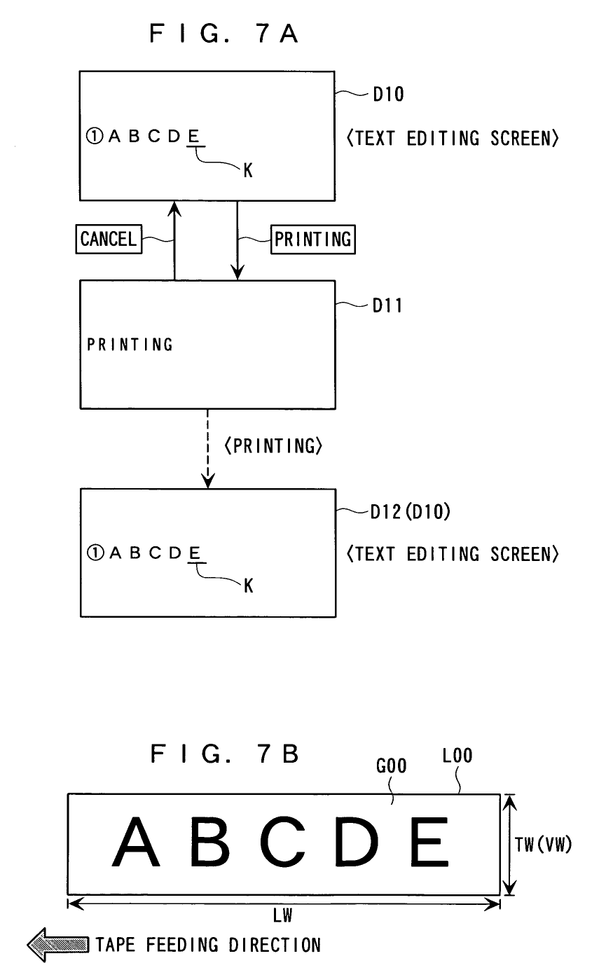

As shown in FIGS. 7A and 7B, when the print key is depressed by the user in a state of display of text edition screen after inputting the first line of character string “ABCDE” up to the cursor K (screen D10: hereinafter the state of the display screen 41 is defined only by means of designation of “screen Dxx” such as D10, D11, D12), a message of “printing” is displayed (D11), and also the character string image of character string “ABCDE” is printed as the print image G00. A label L00 is prepared by cutting according to the setting (FIG. 7B). When the printing is finished, the screen returns to the original text edition screen (D12: same as D10). In the tape printing apparatus 1, the user can delete the various instructions by key input. By depressing the “cancel” key in the above-described state (D11), the screen can be returned to the display state of the original text edition screen (D10).

In the tape printing apparatus 1 according to this embodiment, it is possible to edit and print the desired character string (above-described “ABCDE” or the like) in the stand-alone mode. Here, the printing can be made based on the print image data prepared on the side of the data server DS of this embodiment. Namely, in the arrangement shown in FIG. 1 (first constitution or arrangement), the print image data prepared (stored) in each of the apparatuses (WS1-3, TA or the like) inside the data server DS is outputted by means of downloading, or the like, and is printed. In the arrangement shown in FIG. 2 (second constitution or arrangement), the print image data stored in the personal computer PC (data server DS) is outputted and printed.

A description will hereinafter be made about a relatively simpler printing system SYS of the second arrangement in FIG. 2.

In the data server DS, for example, a text editing screen of various word processor software and various editors (text editor, or the like) which is displayed as a so-called window screen, and an image editing screen of a so-called graphics software, or the like, are hereinafter generically referred to simply as “editing screen.” In addition, the state in which the character string “ABCDE” similar to the above-described screen D10 on the text editing screen as shown in FIG. 7A, or the state in which the character string “ABCDE” is inputted into the above-described image editing screen whereby the image similar to that in FIG. 7B is pictured, are referred to as “the state in which the character string “ABCDE” is inputted and edited on the editing screen.” In addition, the depressing operation of each of the function keys, or the pointing operation by means of various pointing devices as represented by a mouse is simply expressed as “click or clicking” as represented as a click operation (instructing method) by instruction with a mouse pointer.

In the above-described state in which the character string “ABCDE” has been inputted/edited on the editing screen, an instruction is given (selection or click is made) by the user of “print” in “file” which is one of the menus in the “menu bar (or tool bar)” to thereby select/instruct the tape printing apparatus 1 as the designated printer. In the data server DS, a message of “printing” is displayed and/or the instructed “print” is executed in the background (non-display). The print image data of the character string “ABCDE” in the print image G00 and the instruction data (cutting instruction signal) to instruct the kind and timing of the required cutting (in this particular case, full cutting of the rear end as seen in the tape feeding direction in FIG. 7B) are transmitted through the interface IF.

In reply thereto, in the tape printing apparatus 1, while receiving the print image data of the print image G00 and the cutting instruction signal by the DS-IF16, the print image G00 is printed and the rear end is subjected to full cutting to thereby obtain the label L00.

In terms of specification, the following arrangement may also be employed. Namely, the data (text data, or the like) to prepare the print image G00 is transmitted as it is from the data server DS to the tape printing apparatus 1 through the interface IF, and the preparation of (the print image data of) the print image G00 and the label preparation are performed on the side of the tape printing apparatus 1. Further, in the embodiment, although the interface between the data server DS and the tape printing apparatus 1 is arranged to be through the interface IF regardless of various data or control signal, there may be provided a separate system for sending and receiving various control signals (instructing, transmitting and receiving), aside from the interface IF.

As described above, even in case the print image data (or its original text data) is prepared on the side of the data server DS, the user performs the following operations like in the case of the stand-alone type of tape printing apparatus 1. Namely, a desired tape width as the object of printing is estimated, and the tape width which is the precondition for edition on the edition screen, or the like, is set, and the print image data, or the like, is prepared (or loaded from memory medium, or the like) to suit the width of the tape whose setting (i.e., the setting of the tape width) has been made (hereinafter referred to as “set tape width”).

Aside from the above-described set tape width, it is also so arranged in the data server DS that the width of the tape T that has actually been mounted on the tape printing apparatus 1 (hereinafter referred to as “mounted tape width”) can be confirmed. Namely, in the tape printing apparatus 1, the kind of the tape T inclusive of the tape width can be detected by the above-described tape width recognition sensor 141. The result of the detection can therefore be reported to the data server DS through the interface IF.

The mode or style of reporting the information in this case may be such that the information inclusive of the mounted tape width is obtained (analyzed) in the tape printing apparatus 1 based on the kind of the mounted tape T (more particularly, the kind of the tape cartridge C) before reporting as the “mounted tape width” or that the information on the kind of the tape T or the tape cartridge C is reported as it is for subsequent analyzing on the side of the data server DS. The timing of reporting may be such that the reporting is made whenever a new tape cartridge C is mounted on the tape printing apparatus 1 so as to hold the information on the side of the data server DS and that the information is required of the tape printing apparatus 1 when needed by the data server DS, thereby reporting at that point of time.

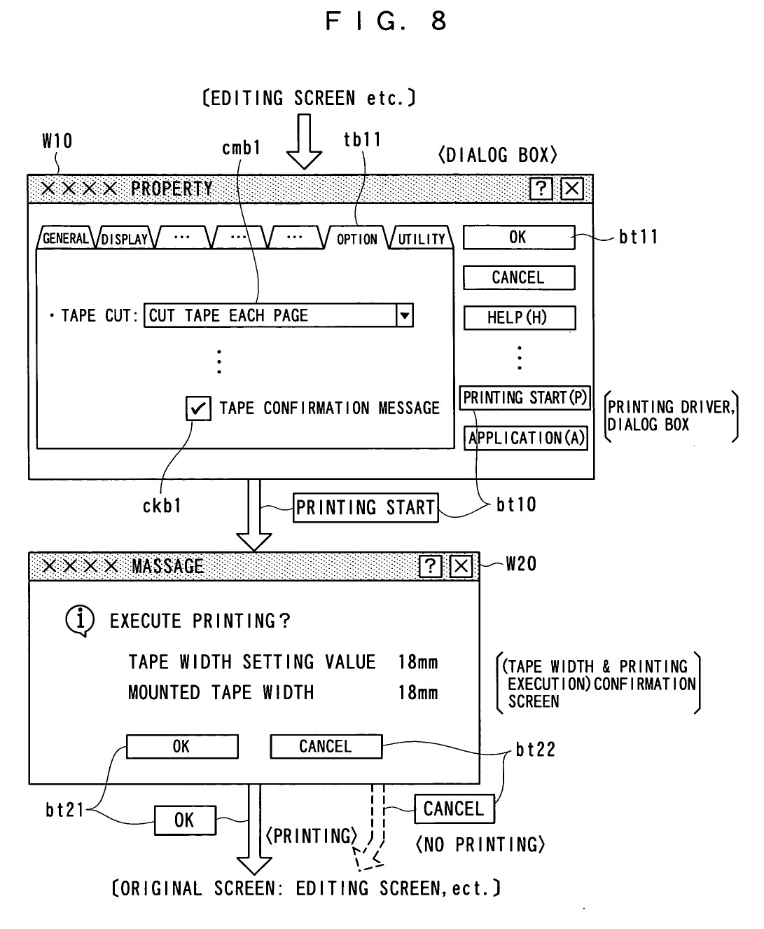

In the data server DS, in response to the selection of option by the user, the value of the set tape width and the value of the mounted tape width are displayed in a side by side relationship to facilitate comparison. In this case, as shown in FIG. 8, while the editing screen and others are being displayed (e.g., in the process of editing) the user clicks the tab tb11 for “option” in a dialog box showing the property, or the like, of the printer driver corresponding to the tape printing apparatus 1 (screen W10). Hereinafter the state of the window screen to be developed on the display screen of the data server DS is referred to as Wxx and illustrated only by means of Wxx. However, unlike the screen Dxx of the above-described tape printing apparatus 1, a plurality of screens are capable of being displayed simultaneously (in parallel with each other or in a partly overlapped manner) and in various sizes.

In this “option” menu screen (W10), by utilizing the combo box cmb1 relating, e.g., to tape cutting, the setting for “tape cutting” can be selected so as to designate to cut the tape after every printing of a print image, so as to designate to cut the tape after printing a plurality of print images, or so as to designate not to cut the tape (i.e., to cut the tape manually). Aside from the above, various options are defined so that the user can arbitrarily make setting and selection thereof.

As one of the functions capable of being arbitrarily set by the user, there is an option to set as to whether “tape confirmation message” shall be displayed or not. As shown in FIG. 8A, by clicking the check box ckb1 of “tape confirmation box” for checking, it is so arranged that the user can display the value of the set tape width and the value of the mounted tape width in a manner to make comparison for the purpose of confirmation.

When the user clicks the button bt10 for sprinting start” (or depresses the key of “P”) in this state (W10), the program proceeds to “printing start.” Then, “tape width set value” (set tape width) and “mounted tape width” are displayed to urge an instruction to select to print or not (confirmation screen W20).

In this state, the dialog box (W10) and the confirmation screen (W20) are displayed together with the original editing screen. When the user clicks the “OK” button bt11 in the state of the above-described dialog box (W10), after validating the state of various settings inclusive of the setting of “tape confirmation message,” the screen (W10) is closed to return to the original editing screen. Therefore, when the user clicks the “printing” in the “file” menu, the above-described confirmation screen (W20) is displayed at that point of time. In this case, since the dialog box (W10) is closed, the display becomes a state in which only the original editing screen and the above-described confirmation screen (W20) are displayed in parallel with each other.

In the above-described confirmation screen (W20), the “mounted tape width 18 mm” showing the mounted tape width TW=18 mm is displayed relative to the “tape width set value 18 mm” showing the set (estimated, imaginary) tape width VW=18 mm. Therefore, when the “OK” button bt21 is clicked by the user after confirming the display, the data server DS operates to close the confirmation screen (W20) and the program proceeds to the instructed “printing” processing, whereby printing is executed. In concrete, the print image data for the print image G00 of the character array “ABCDE” shown, e.g., in FIG. 7B and the corresponding cutting instruction signal are transmitted to the tape printing apparatus 1 through the interface IF. The tape printing apparatus 1 receives the print image data and the cutting instruction signal by the DS-IF 16 and prints the print image G00, to thereby prepare the label L00 by subjecting the rear end of the tape to full cutting (FIG. 7B).

In the above-described confirmation screen (W20), if the “cancel” button bt22 is depressed by the user, the data server DS operates to close the confirmation screen (W20) and also to cancel the instructed processing of “printing” (instruction shown by dotted line arrow). In the data server DS, irrespective of whether the “printing” has been executed or not, the confirmation screen (W20) is closed. If the procedure is at the stage of “printing start”, the original editing screen and the dialog box (W10) are displayed in parallel with each other and, if the procedure is at the stage of “printing”, the program returns to the displaying of the original editing screen.

An explanation has so far been made of an example in which the tape width setting value and the mounted tape width coincide with each other (see W20 in FIG. 8), hence “set tape width VW=mounted tape width TW.” The printing system SYS of this embodiment is so arranged that the printing can be executed (forcibly performed) without any problem even in case “set tape width VW≠mounted tape width TW.”

In other words, particularly in a separate type of printing system SYS, it is highly possible that the set tape width VW which is estimated or set by the user is different from the mounted tape width TW that has been prepared and mounted on the side of the tape printing apparatus 1 (i.e., “set tape width VW≠mounted tape width TW”). Especially when a plurality of users use the printing system SYS in common like in the first embodiment shown in FIG. 1, this possibility becomes high. The printing system SYS of this embodiment can forcibly execute the printing under such circumstances. An explanation will now be made about such a feature.

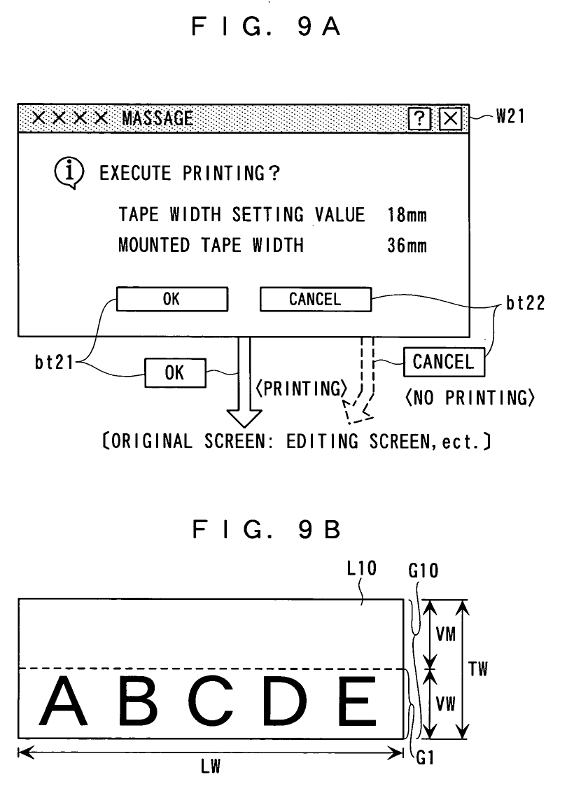

When the “printing start” button bt10 of the above-descried dialog box (W10) (or “printing” in “file” menu) is clicked, as shown in FIG. 9A, there is displayed a confirmation screen “mounted tape width 36 mm” showing the mounted tape width TW=36 mm relative to the “tape width set value 18 mm” showing the set tape width VW=18 mm (W21). In other words, in this case, the condition is met of “set tape width VW<mounted tape width TW.”

Here, when the “OK” button bt21 is depressed by the user as it is, the data server DS operates to close the confirmation screen (W21) and forcibly execute the instructed “printing.” As shown in FIG. 9B, instead of the print image data (basic image data) of print image (basic image) G1 of character array “ABCDE” similar to the one prepared to suit the set tape width VW=18 mm, there are transmitted to the printing apparatus 1 a print image data (deformed image data) G10 which is made up of the print image G1 on the illustrated lower half and a margin width data showing a margin of a margin width (set margin width) VM=18 mm on an upper half thereof, as well as a cutting instruction signal corresponding thereto. The tape printing apparatus 1 receives them and prints the print image G10, thereby preparing a label L10 by executing full cutting at the rear end of the tape.

In this case, the following arrangement may alternatively be employed. Namely, after printing or after preparing the label, the portion corresponding to the margin width VM=18 mm on the upper half is cut so that a label of an estimated set tape width VW=18 mm can be prepared. Dotted lines, or the like, which serve as the guide for cutting may also be printed.

In the above-described confirmation screen (W21), when the “cancel” button bt22 is clicked, the confirmation screen (W21) is similarly closed and the instructed “printing” processing is cancelled (instruction as indicated by dotted lines).

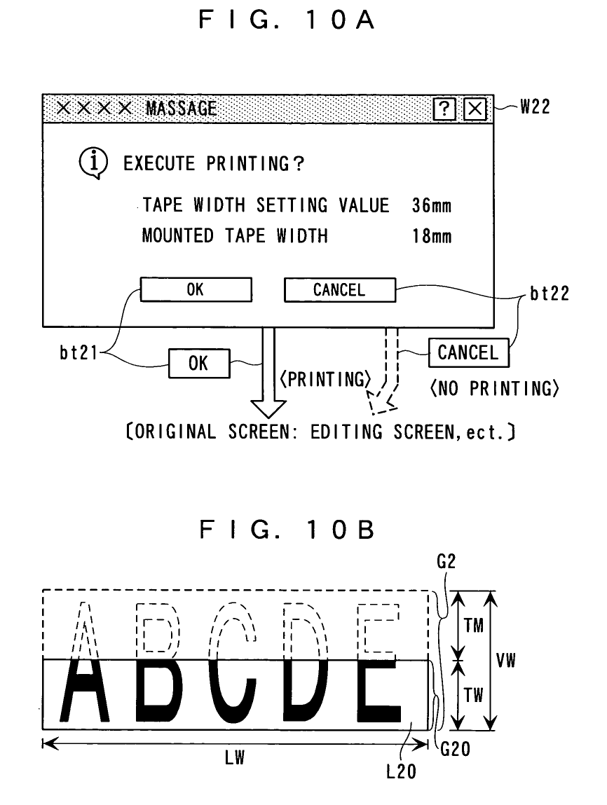

On the other hand, in a state in which “set tape width VW>mounted tape width TW”, when the above-described “printing start” button bt10, or the like, is clicked, there is displayed a confirmation screen, as shown in FIG. 10A, of “mounted tape width 18 mm” indicating the mounted tape width TW=18 mm relative to “tape width set value 36 mm” indicating the set tape width VW=36 mm (W22).

If the “OK” button bt21 is clicked as it is, the confirmation screen (W22) is closed and the instructed “printing” job is forcibly executed. As shown in FIG. 10B, instead of the print image data (basic image data) of the print image (basic image) G2 that has been prepared to suit the set tape width VW=36 mm, the print image data (deformed image data) of the print image (deformed image) which is made up of the lower half as illustrated and the cutting instruction signal corresponding thereto are transmitted. Based on the above, the print image G20 is printed to thereby prepare a label L20 by executing full cutting at the rear end thereof. As regards the “cancel”, the same procedure applies (shown by dotted line arrow).

In other words, in this case, out of the print image data of the print image (basic image) G2 of the set tape width VW=36 mm, deletion width data corresponding to deletion width (mounting margin width) TM=18 mm is deleted and, consequently, the print image data of the print image (deformed image) of the mounted tape width TW=18 mm is extracted, thereby preparing the label L20.

As described above, according to the printing system SYS of this embodiment, in the data server (outputting apparatus) DS, when the mounted tape width that is reported by the tape printing apparatus 1 is different from the set tape width VW that is estimated (set) in advance are different from each other, the basic image data showing the basic image that has been prepared (stored) to suit the set tape width VW is deformed to suit the mounted tape width TW to thereby prepare a deformed image data showing the basic image. The deformed image data is outputted, as the print image data, to the tape printing apparatus 1 through the interface IF. When the tape widths are equal to each other, either may be outputted as the print image data since the basic image data=deformed image data.

In the above-described case, the image data to be outputted as the print image data becomes the image data that suits the mounted tape width TW when the tape widths are different, as well as when both the tape widths are equal to each other. Therefore, no problem arises. Namely, even in case there can be made available only a tape T of the mounted tape width TW which is different from the set tape width VW, the method of deforming the image data (predetermined method of printing: given printing method) can be determined so as to be prepared in advance for such a situation. As a result, the printing can be forcibly executed without a particular problem.

In the printing system SYS, as described with reference to in FIGS. 9A-9B and 10A-10B, data server DS operates to perform the following. Namely, when the printing instruction has been given and in case the tape width is different, the printing instruction can be cancelled or the forcible (or forced) execution of printing (OK) can conveniently be instructed (instruction for forcible execution) on the confirmation screen (W21) or on the confirmation screen (W22). When the instruction of forced printing is given, the deformed image data showing the deformed image G10 or deformed image G20 is outputted to the tape printing apparatus 1. Therefore, the image data suitable for the mounted tape width TW is outputted, giving rise to no particular problem.

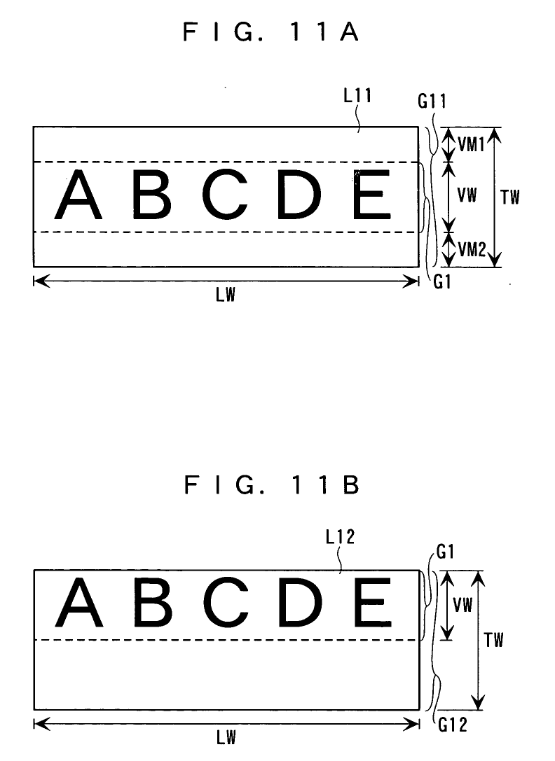

In the above-described embodiment, in the case of “set tape width VW<mounted tape width TW” , a margin width (set margin width) VM=18 mm is provided on the upper side of the figure, and the print image (basic image) G1 of set tape width VW=18 mm is disposed (or the image data is deformed so as to be disposed) on the lower side of the figure, whereby printing is executed. Alternatively, the following arrangement may be made as shown in FIG. 11A. Namely, a margin width VM1=VM2=9 mm is provided on both the upper side and the lower side so as to dispose the print image (deformed image) G11 in the center in the illustration, or a margin width VM=18 mm is provided on the lower side so as to dispose the basic image G1 on the upper side as seen in the illustration (FIG. 11B), thereby obtaining the print image (deformed image) G12. Printing is made in the manner as described above to prepare the label L11 or L12.

In these cases, it may be so arranged that the surplus margin width VM (=VM1+VM2)=18 mm is cut after printing or after preparing the label, thereby preparing a label of imagined set tape width VW=18 mm.

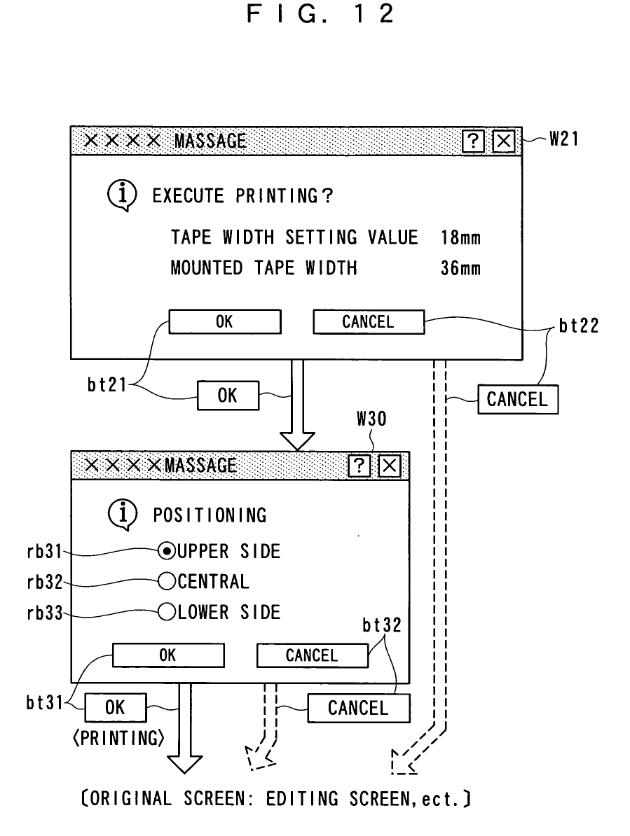

Furthermore, it may also be so arranged that the position to dispose the basic image G1 can be selected. In this case, as shown in FIG. 12, when the “OK” button bt21 is clicked to instruct the “forced printing” in the confirmation screen (W21: same as FIG. 9), a selection screen to urge the selection of the position of disposition is displayed (W30). This selection screen (W30) displays therein a plurality of selection options of “upper side”, “center”, and “lower side.” The user clicks each of the corresponding radio buttons rb31-rb33 so as to select the one with a solid black circle in the center thereof (“upper side” in the illustrated example). When the “OK” button bt31 is clicked after the result of this selection has been confirmed by the user, the selection screen (W30) is closed. If the confirmation screen (W21) is not closed yet, this is also closed at the same time and then forcibly execute the “printing.” On the other hand, as to canceling, the same operations apply as those described with reference to FIGS. 9 and 10 (illustrated by dotted lines).

As described above, the position of the basic image G1 (the position of disposition of the basic image) inside the deformed image G10 which has been prepared by adding the margin to the basic image G1 can be selectable. Therefore, after disposing the basic image G1 at an arbitrary position of a large-width tape T that can be made available and then printing it, the surplus margin VM, or the like, is cut off. As a result, the label of the print image G1 having the desired width can be obtained. In this case, a plurality of options include: the basic-end side position (lower side) in which the basic end (e.g., lower-end side in the figure) which is one end of tape width direction of each of the images is made to coincide with each other; the opposite-end side position (upper side) in which the opposite end (the other end) is made to coincide with each other; and central position (center) in which the central line of each of the images is made to coincide with each other. By selecting one of the above, deformed image data having the desired position of disposition can be easily prepared and the desired print image can be easily printed.

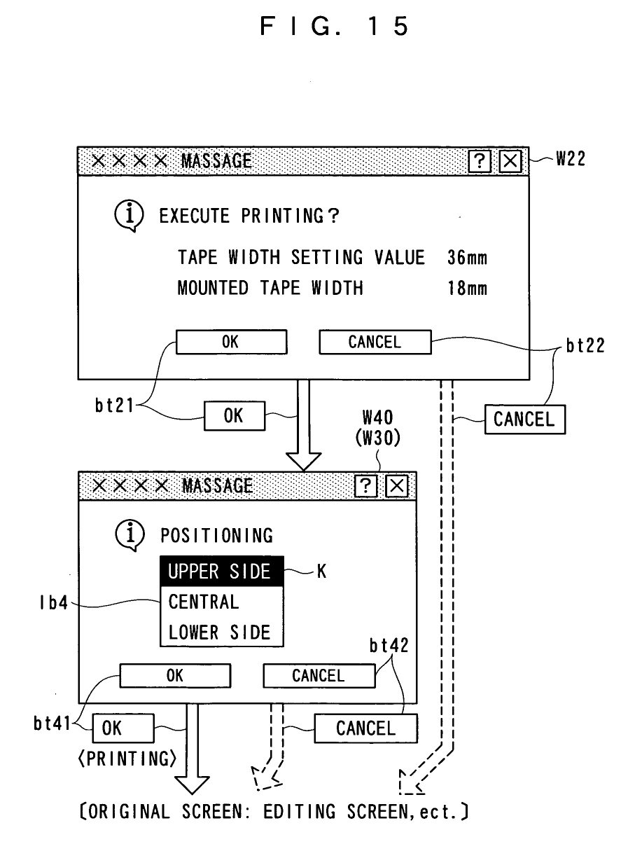

In the example as shown in FIG. 12, the method of selecting (instructing) the selection screen is made with a radio button. Alternatively, a combo box type (see cmb1 in FIG. 8) or a list box type (see 1b4 in FIG. 15) may also be employed. Further, in the above-described example, the selection screen is displayed at the point of time of instructing “forced printing.”

Alternatively, it may be so arranged that the similar selection screen is displayed out of the menu such as editing screen, or the like, to enable selection. The selection/setting before issuing instruction of “forced printing” is set as default and the default setting may be arranged to be selectable again at the time of instructing “forced printing.” Or else, only when default is not designated, the selection screen may be arranged to be selectable at the time of instructing “forced printing.”

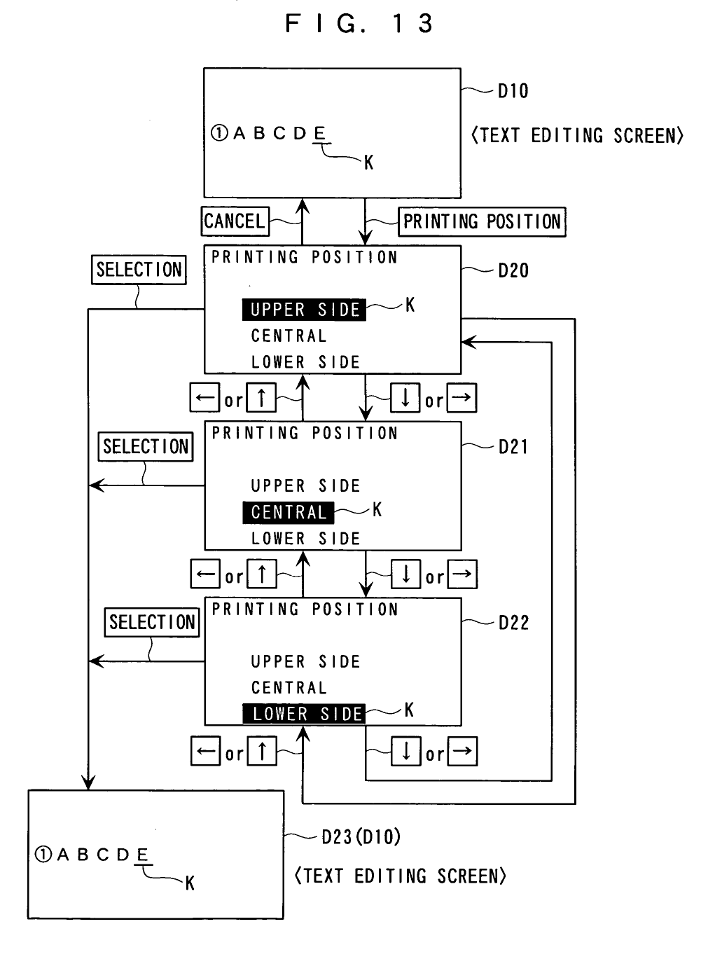

In the above-described example, the position of disposition of the basic image G1 is arranged to be selected on the side of the data server (outputting apparatus) DS. It may alternatively be so arranged that the selection can be made on the side of the tape printing apparatus 1. In this case, as shown in FIG. 13, if the printing position key is depressed by the user in the state in which the text editing screen, or the like, is displayed (D10: same as FIG. 7A), the selection screen of the printing position (in this case, the position of disposition of the basic image) is displayed (D20). In this state (D20), the user selects and displays a desired option from menu by cursor movement (i.e., by moving the cursor K each of the menu items is displayed in reverse video: selective display is made of “upper side” in D20, “center” in D21, and “lower side” in D22). By depressing the selection key, the selection is fixed. Once any one of the menu items has been fixed, the screen returns to the original text editing screen (D23: same as D10).

In the above-described example, the position of disposition of the basic image G1 can be selected out of a plurality of options also in the tape printing apparatus 1, and the result of selection can be reported to the data server (outputting apparatus) DS. Therefore, it is possible to print the print image of the position of disposition according to the selection on the side of the tape printing apparatus 1. Alternatively, it may be so arranged that the selection can be made both on the side of the data server DS and on the side of the tape printing apparatus 1. As to which of the result of selection by the data server DS and the result of selection by the printing apparatus 1 shall be given priority, may be arbitrarily determined in terms of specification. One of the two may be made a choice in default designation in case it is not selected, or else the specification may be so made, without giving priority, as to employ the result of selection made last.

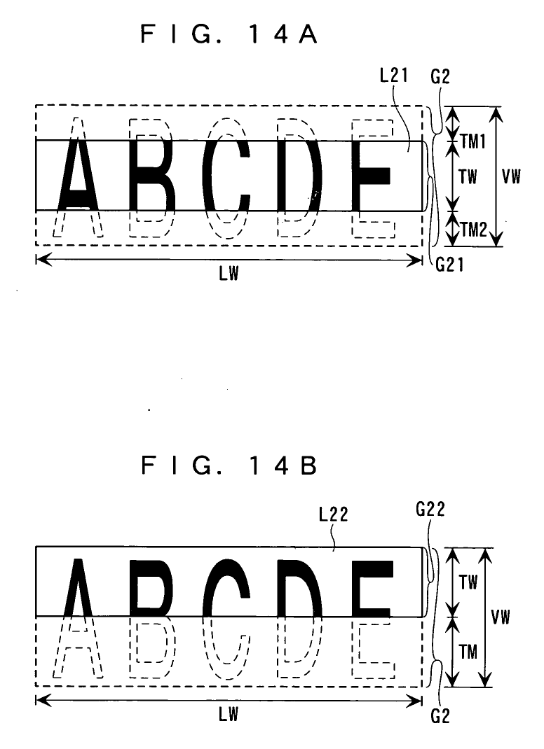

In the above-described example, in case “set tape width VW>mounted tape width TW”, the following manner of printing is employed. Namely, instead of the print image data (basic image data) of the print image (basic image) G2 that has been prepared to suit the set tape width VW=36 mm as shown in FIG. 10B, the deletion width data corresponding to the deletion width (width for mounting margin) on the upper side as shown in FIG. 10B is deleted or the lower side thereof is extracted, the print image data (deformed image data) of the print image (deformed image) G20 of the mounted tape width TW=18 mm is outputted (transmitted) to thereby print it. Aside from the above-described example, the following manner of printing may alternatively be employed. Namely, as shown in FIG. 14A, the portions corresponding to the upper and lower deletion widths TM1=TM2=9 mm are deleted or the center thereof is extracted to thereby print the deformed image G21 of the mounted tape width TW=18 mm corresponding to the central portion of the basic image G2. Or else, the portion corresponding to the deletion width TM=18 mm as shown on the lower side of FIG. 14B is deleted or the upper side thereof is extracted to thereby print the deformed image G22 of the mounting tape width TW=18 mm on the upper side, as illustrated, of the basic image G2. Label L21 or label L22 is thus prepared.

Alternatively, it may be so arranged that the position of extraction of the deformed image from the above-described basic image G2 is selectable. In this case, as shown in FIG. 15, when the “OK” button bt21 is clicked to thereby instruct “forced printing” in the confirmation screen (W22: same as FIG. 10A), there is displayed a selection screen to urge the selection of the extraction position (W40). On this selection screen (W40) there is displayed a list box 1b4 in which, e.g., a plurality of options of “upper side”, “center”, and “lower side” of the extraction positions are listed as illustrated. Therefore, the user can select a desired option (“upper side” in the illustrated example) by cursor designation (designation in reverse video in black and white by cursor K movement). When the “OK” button is clicked after the selection/confirmation by the user, the selection screen (W40) is closed, and the confirmation screen (W22) is also closed if it is not. Thereafter, the instructed “printing” is forcibly executed. The cancellation is performed in the same manner as above (shown in dotted lines).

In the above-described example in FIG. 15, the selection screen is made of a list box type. It may of course be made of a combo box type (see cmb1 in FIG. 8) or of a radio button type (see rb31-33 in FIG. 12). Further, the display timing may also be made to be selectable from direct display of the menu of the editing screen, or the like. Or else, it may be arranged to be selected and designated by making default setting in advance so that, only when the default designation is not made, selection can be made at the time of designating “forced printing.” In addition, as regards the position of extraction of the deformed image, it may be so arranged that the selection can be made on the side of the tape printing apparatus 1. In this case, since the result of selection of the position of extraction of the deformed image can be reported to the data server (outputting apparatus) DS, there can be printed a print image (deformed image) of the extracted position according to the selection on the side of the tape printing apparatus 1. It may also be so arranged that the selection can be made both on the side of the data server DS and on the side of the tape printing apparatus 1. The priority in such a case may be arbitrarily determined from the viewpoint of specification, or one of the two may be designated as default or, without giving priorities, the result of selection of the latest selection may be employed.

As described hereinabove, if the widthwise position of the deformed image G20, or the like (G20, G21 or G22) to be extracted from the basic image G2 (position of extraction of the deformed image) can be selectable, widthwise part of respectively different positions is extracted to thereby print them in a plurality of sheets for patching them together. As a result, a tape (or a label by cutting it) of the print image G2 of a desired width can be prepared. In this case, as a plurality of options, the following are included: namely, a reference-end side position (“lower side”) in which the reference end which is one end of the widthwise direction of the tape of each image (lower side in the illustrated example) is made to coincide; an opposite-end side position (“upper side”) in which the opposite end (upper side in the illustrated example) is made to coincide; and a central position (“center”) in which the center line of each of the images is made to coincide. By selecting one of the above, the deformed image data of the desired position of extraction can be easily prepared and a desired print image can be easily printed.

In case extraction is made of the above-described deformed image, the set tape width VW a mounted tape width TW, hence set tape width VW+mounted tape width TW (hereinafter “set tape width/mounted tape width”)≧1. In the above-described example, set tape width/mounted tape width=36/18=2. Therefore, if limited only to the above-described example and an example of 1≦set tape width/mounted tape width≦2, the option may be made only to “upper side” and “lower side.” In this case, after selecting and printing, e.g., the “upper side”, the “lower side” is selected and the second sheet is printed. Then, by adhering the second sheet in parallel, or in a partially overlapped manner, the print image G2 of the desired set tape width VW (=36 mm) can be prepared as a label, and can therefore be adhered in using it.

In that sense, the “upper side” may be expressed as “½” (one-half or one over two), and the “lower side” as “2/2” (two over two). Oppositely, the “lower side” may be expressed as “½” and the “upper side” as “2/2.” Similarly, the above-described “upper side” (opposite-end side position), the “center” (central position), and the “lower side” (reference-end side position) may be expressed as “⅓” (one-third), “⅔” (two over three), “3/3” (three over three), or in the opposite order. This may be applied to the above-described example of the set tape width/mounted tape width=36/18=2. If the “⅓” through “3/3” are sequentially selected and printed to thereby prepare labels, by closely adhering in a partially overlapped manner, labels in which the print image G2 of the desired set tape width VW (=36 mm) is printed can be prepared and adhered.

Here, let us consider a natural number n which meets a condition of n≧set tape width, and the width of the basic image is equally divided into n pieces. Since the width of each of the divided images is set tape width/n, it naturally becomes smaller than the mounted tape width, which is a width capable of disposing the deformed image having the mounted tape width. The number n at this time may be determined in advance out of the maximum value of the set tape width VW that can be set, the minimum value of the mounted tape width that can be mounted, or the like. Alternatively, it may be determined at the time when the set tape width VW has been set and the mounted tape width TW has been reported (detected), thereby fixing both. Or else, it may be determined right before displaying the selection screen which is similar to the above-described screen (W40) in FIG. 15 which displays the options such as “1/n” (actually ⅓, or the like) for selection.

In these cases, as the options for the position of extraction of the deformed image, there are included n pieces of options that can be designated so as to be disposed inside the deformed image. Therefore, by sequentially selecting and printing them, at least widthwise one-“n”th (one over “n”) of the desired print image is extracted and print in n sheets on the narrow-width tape T that is made available. As a result, by adhering the n pieces together, there can be prepared a tape (or a label to be obtained by cutting it) having a full width of the desired print image.

In the above-described embodiment, when “set tape width VW<mounted tape width TW” among “set tape width VW≠mounted tape width TW”, the basic image is disposed and the margin width is added to thereby expand the width (addition to the widthwise direction) to the mounted tape width. When “set tape width VW>mounted tape width TW”, the portion corresponding to the width of the deformed image is extracted (widthwise extraction) from the basic image. Aside from the above, when “set tape width VW<mounted tape width TW”, the deforming method image can be expanded to the mounted tape width TW. When “set tape width VW>mounted tape width TW”, the basic image can also be reduced. The enlargement/reduction in this case may be enlargement/reduction only in the widthwise direction or enlargement/reduction inclusive of the longitudinal direction (i.e., those to be reflected in the printing length or label length).

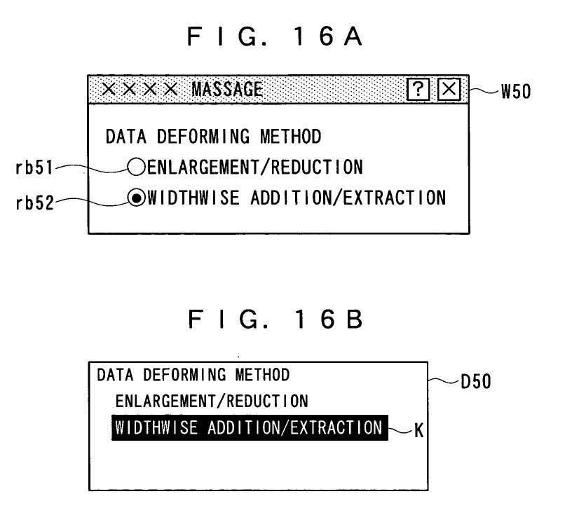

When the former is defined as the deforming method by “widthwise addition/extraction”, and the latter is defined as the deforming method by “enlargement/reduction”, both may be employed in a manner to be able to elect one. In this case, as shown in FIG. 16A, selection can be made by displaying a selection screen (W50) in which selection can be made by radio buttons rb51-rb52. This selection screen (W50) may be displayed at the time of instructing the “forced printing” or may be arranged to be selectable by displaying a similar selection screen from the original editing screen, or the like. Otherwise, the selection/setting before instructing “forced printing” is set as default so that selection can be made at the time of instructing “forced printing.” Or else, it may be so arranged that selection can be made at the time of instructing “forced printing” only when default-setting is not made.

Not only on the side of the data server (outputting apparatus) DS but also on the side of the tape printing apparatus 1, may the following arrangement be made. Namely, the selection screen as shown in FIG. 16B is displayed (D50) by operating a particular key from the state in which the text editing screen is displayed so that the selection can be made by cursor operation, or the like. In this case, also in the tape printing apparatus 1, the above-described deforming method (“enlargement/reduction”) by enlargement/reduction of the image or the deforming method (“widthwise addition/extraction”) by extracting/adding the image width can be selected, and the result of the selection can be reported to the data server (outputting apparatus). Therefore, any one of the deforming methods can be employed according to the selection on the side of the printing apparatus 1. Also in this case, the order of priority when the selection is made possible in both the data server DS and the tape printing apparatus 1 may be arbitrarily determined from the viewpoint of specification. Otherwise, one may be designated as default and the result of selection made last time may be employed.

In the above-described example, “tape confirmation message” is made effective in the dialog box (W10) in FIG. 8. Therefore, it is possible to display in FIGS. 9A and 10A the above-described confirmation screen (W21, W22) so that the forced printing (OK) and canceling can be selected. As regards the processing of “setting tape width VW≠mounted tape width TW” when the check of “tape confirmation message” is not made thereby making it ineffective, either “forced printing” or “cancel” may be defined in terms of specification. Depending on the printing instruction (inclusive of the one by “printing start” button and “printing” in menu), the confirmation screen may be displayed to urge the selecting instruction as to whether “forced printing” or not. The confirmation screen may be something which is obtained by removing the display regarding the tape width out of the above-described confirmation screen (W20-W22), i.e., the one having only the display to ask “forced printing” or not as well as “OK” and “cancel” buttons to respond to the question.

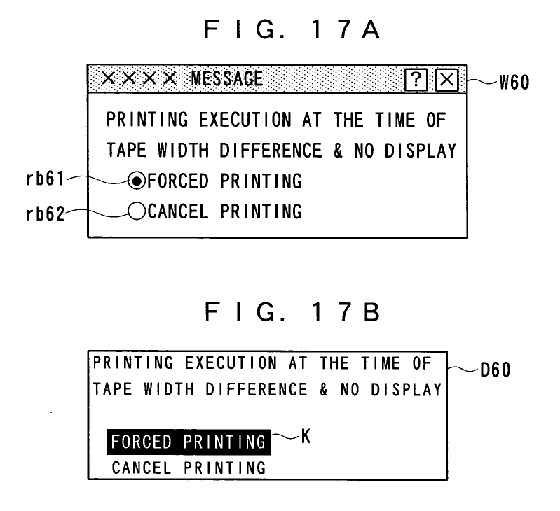

It may also be so arranged that the “forced printing” and “cancel” can be selected in advance and designated. Further, the order of priority in using together the above-described method of selecting in advance and the above-described confirmation screen for “forced printing” may be arbitrarily determined in terms of specification. One may be made as default designation or, without giving the order of priority, the result of selection that has been made last time may be employed. In these cases, as shown in FIG. 17A, the selection screen (W60) selectable by radio buttons rb61-rb62 is displayed for selection. This selection screen (W60) may be displayed at the time when “printing” is instructed, or it may be so arranged that a selection can be made by direct display from the menu, or the like, of the original editing screen.

Not only in the data server (outputting apparatus) side DS but also in the tape printing apparatus 1 can the selection screen (D60) as shown in FIG. 17B be made in the tape printing apparatus 1 by cursor operation, or the like. In this case, “forced printing” or not can be selected also in the tape printing apparatus 1, and the result of selection can be reported to the data server (outputting apparatus) DS. Therefore, employment may be made according to the selection on the part of the tape printing apparatus 1. In this case, the order of priority for making selectable on both the data server DS side and on the tape printing apparatus 1 may be arbitrarily selected in terms of specification. One of the two may be designated as default or without giving priority, the result of selection made last time may be employed.

In the above-described embodiment, the print image data (or the text data which makes the original thereof) is to be prepared on the part of the data server DS. As the method of preparing, examples were given of a case in which the print image data is prepared inside the data server DS, and a case in which unloading is made from a memory media, or the like. In the latter case, as shown, e.g., in FIG. 2 (second constitution), the image data can be outputted as (basic) image data that has already been prepared from outside in the form of a compact disc (CD, CD-ROM) 501, or the like. Various basic image data can thus be prepared only by exchanging the CD-ROM 501 or can be changed to suit purposes, or the like.

As regards the control program (processing program: exclusively used application program) for executing various processing, it may be prepared (stored) in the data server DS from the beginning. Or else, it may be singly stored in the CD-ROM 501 together with the files, or the like, inclusive of the image data so that it may be booted by downloading, or the like. In this case, if the application is made to be one which can be executed by an ordinary operation system (OS), it can be used only by mounting the CD-ROM 501 having the OS therein, onto the personal computer, or the like.

Although the CD-ROM was exemplified in the above-described example, other recording media such as FD, MO, DVD, or the like may also be used as well. In case the network is used as shown in FIG. 1 (first constitution), unlike the one shown in FIG. 2, various data files or various programs can be received from various other apparatuses (WS2, WS3, or the like, in the illustrated example) connected to the network NW, through the network NW or through the apparatus that is directly connected to the tape printing apparatus 1 (outputting apparatus: PC1 or TA in the illustrated example). Therefore, it is possible, only by receiving from other various apparatuses, to store (prepare) or change various new data files or programs. In these cases, it is possible for the program on the side of the data server DS to contain, by downloading, part of the program on the side of the printing apparatus 1.

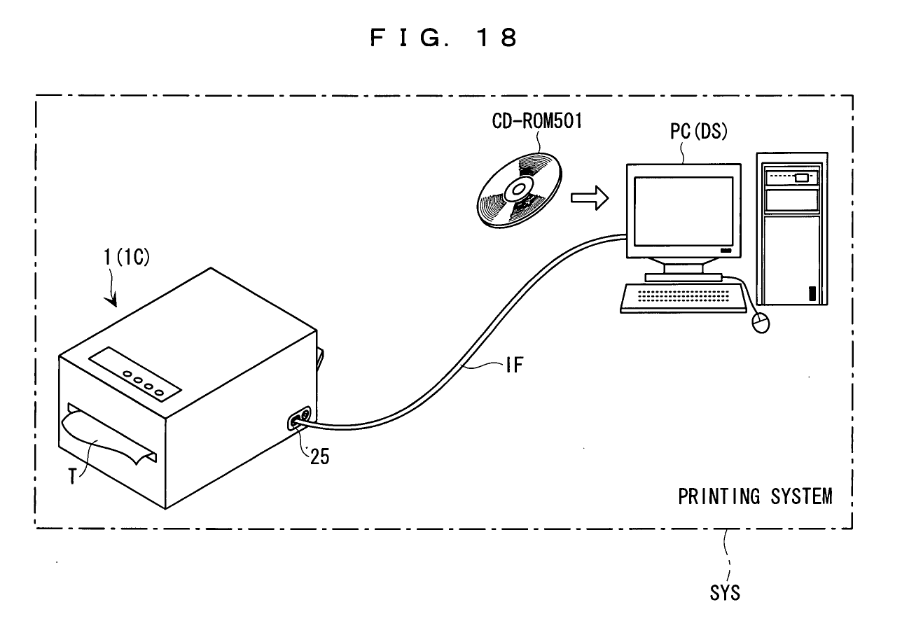

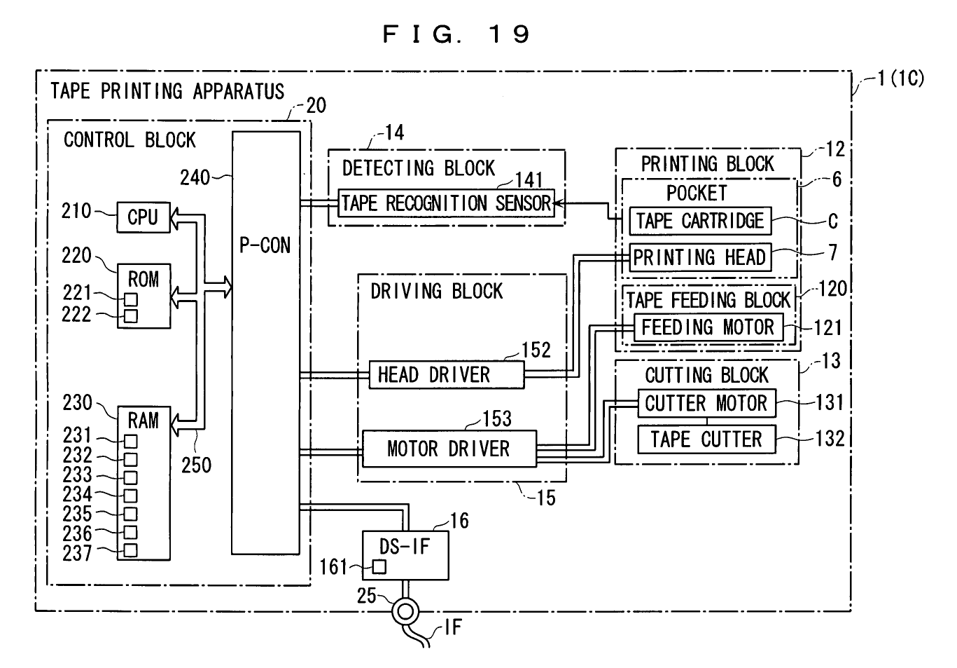

In the above-described example, there was cited the tape printing apparatus 1 which is provided with the operation block 11 having the keyboard 3, display 4, or the like. However, in case most operations are executed by the instructions from the data server DS, the operation block 11 is not required on the side of the tape printing apparatus 1. Therefore, such a function may be deleted. For example, there may be employed a constitution like a tape printing apparatus 1C in which the operation block 11, or the like, is omitted as shown in FIGS. 18 and 19.

The above-described various processing methods (various methods of preparing labels, methods of data processing, or the like) of the printing system SYS can also be applicable to a program to be processed in the various programmable printing systems, as well as to a storage medium which is used for storing the program therein. By storing this kind of program, or by reading the program out of the storage medium, or the like, or by downloading it through the network to thereby execute the program, the printing can be executed without giving rise to a particular problem even in case the set tape width for the image data prepared for printing and the mounted tape width are different from each other, i.e., even in case the set tape width as set by the outputting apparatus to output the data and the mounted tape width as mounted on the tape printing apparatus are different from each other.

Modifications to the above-described examples are possible without departing from the spirit of this invention.

As described hereinabove, according to the printing system, the method of data processing, the program, and the storage medium of this invention, the printing can be forcibly executed without giving rise to a particular problem even in case the set tape width as set by the outputting apparatus which outputs the data and the mounted tape width as mounted on the tape printing apparatus are different from each other.

1. A printing system comprising:
an outputting apparatus for outputting print image data through an interface; and
a tape printing apparatus for printing on a tape a print image based on the print image data outputted through the interface,
wherein said tape printing apparatus comprises tape width reporting means for reporting to said outputting apparatus a tape width of the tape mounted thereon as a mounted tape width, and
wherein said outputting apparatus comprises:
basic image storing means for storing basic image data of a size to suit a set tape width that has been set in advance;
deformed image forming means for preparing deformed image data by deforming the basic image data into a size to suit the mounted tape width when the set tape width and the mounted tape width are different from each other; and
image data outputting means for outputting the deformed image data to said tape printing apparatus as the print image data.

2. The printing system according to claim 1, wherein said outputting apparatus comprises:
printing instruction means for giving instruction to print the print image;
printing instruction canceling means for canceling the printing instruction when the printing instruction is given and when the set tape width and the mounted tape width are different from each other; and
forced printing instruction means for instructing forced printing of the printing image when the printing instruction is given and when the set tape width and the mounted tape width are different from each other;
wherein said image data outputting means outputs the deformed print image data as the print image data when the forced printing instruction is given.

3. The printing system according to claim 1, wherein said deformed image forming means comprises at least one of:
image enlarging/reducing means for forming the deformed image data by deforming the basic image data in order to enlarge or reduce the widthwise size of the basic image data to suit the mounted tape width; and
image width extracting and adding means for extracting from the basic image data an amount equivalent to the mounted tape width when the set tape width is above the mounted tape width, thereby forming the deformed image data, and for adding to the basic image data a margin width data to thereby increase the basic image data to an amount equivalent to the set tape width when the set tape width is below the mounted tape width, thereby forming the deformed image data.

4. A method of data processing in a printing system which prints on a tape a print image based on print image data outputted from an outputting apparatus to a tape printing apparatus trough an interface, said method comprising:
the tape width reporting step for reporting to said outputting apparatus a tape width of the tape mounted thereon as a mounted tape width;
basic image storing step for storing into said outputting apparatus basic image data of a size to suit a set tape width that has been set in advance;
deformed image forming step for forming deformed image data by deforming the basic image data into a size to suit the mounted tape width when the set tape width and the mounted tape width are different from each other; and
image data outputting step for outputting the deformed image data by said outputting apparatus to said tape printing apparatus as the print image data.

5. A program for effecting each of the means in the printing system as claimed in claim 1.

6. A program for effecting the method of data processing in the printing system as claimed in claim 4.

7. A storage medium for storing the program as claimed in claim 5 or 6 in a manner to be readable by a programmable printing system.
